(19) United States
(12) Patent Application Publication
(10) Pub. No.: US 2022/0402783 A1
(43) Pub. Date: Dec. 22, 2022

(54) OIL-CONTAMINATED SOIL AND GEROUND WATER TREATMENT SYSTEM

(71) Applicant: KUN-LIANG HONG, TAINAN CITY (TW)

(72) Inventors: CHIH-MING KAO, KAOHSIUNG CITY (TW); KUN-LIANG HONG, TAINAN CITY (TW); PO-JUNG HUANG, KAOHSIUNG CITY (TW); YU-SHAN CHO, KAOHSIUNG CITY (TW); CHIH-CHIEH WANG, KAOHSIUNG CITY (TW); WING-SZE HO, KAOHSIUNG CITY (TW); RAO Y. SURAMPALLI, LENEXA, KS (US)

(21) Appl. No.: 17/807,768

(22) Filed: Jun. 20, 2022

(30) Foreign Application Priority Data
Jun. 21, 2021 (TW) 110122587

(51) Int. Cl. C02F 1/461; C02F 1/467; B09C 1/08

(52) U.S. Cl. CPC C02F 1/46109; C02F 1/4618; C02F 1/4674; B09C 1/085; C02F 2103/06

(57) ABSTRACT

An oil-contaminated soil and groundwater treatment system, in which the polluted groundwater pumped into the electrocatalytic device uses a high-voltage electric field to change the structure of water molecules. After high voltage discharge, electrocatalysis and electrolysis, alkaline reduced water, acidic oxidized water and neutral water can be quickly produced. By the oxidation effect of electrocatalytic device anode, chloride ions and dissolved oxygen in water generate hypochlorous acid and superoxide ions, and the interaction between the two generates hydroxyl radicals and microbubbles with high oxidizing ability and long-lasting oxidation, thereby effectively remediating soil and groundwater polluted by total petroleum hydrocarbons.

### BACKGROUND OF THE INVENTION

### 1. Field of the Invention

The present invention relates to an oil-contaminated soil and groundwater treatment system, especially a treatment system that uses electrocatalytic technology to generate hydroxyl radicals and microbubbles with high oxidizing ability and long-lasting oxidation, thereby effectively remediating total petroleum hydrocarbon (TPH) polluted soil and groundwater.

### 2. Description of the Related Art

Old, corroded and disrepaired storage tanks and pipelines, stratum subsidence changes and improper operation or management, can cause rupture and damage of storage tanks and pipelines and leakage of stored materials in storage tanks to pollute soil or groundwater. When the underground oil tank pipeline of the gas station leaks slowly due to earthquake or corrosion, the surrounding soil and groundwater are polluted. If the oil spills and pollutes the groundwater downstream, and the groundwater is polluted, the difficulty of remediation and the cost of remediation are quite high. Moreover, the gas stations are all located in densely populated areas, which makes the remediation time schedule urgent.

Contamination of soil and groundwater by fuel oil, gasoline, diesel and other petroleum hydrocarbons is an increasingly common and serious problem. The main sources of oil pollution include oil spills from underground storage tanks (USTs), oil pipeline ruptures, and accidental oil spills on the ground. There are more than 3 million oil storage tanks in the United States, and it is estimated that 35% of the oil storage tanks may be leaking oil (Kim et al., 2015; Apul et al., 2016). In Taiwan, oil pollution is also the main source of soil and groundwater pollution. The main components of oil products include total petroleum hydrocarbons (TPH), gasoline additives—methyl tertiary-butyl ether (MTBE), BTEX (benzene, toluene, ethylbenzene, xylenes) and TMB (1,2,4-trimethylbnene and 1,3,5-trimethylbenzene) can cause harm to human body. When the leakage of oil pollutants occurs, the pollutants first penetrate into the unsaturated layer, and then, according to the characteristics of the pollutants, soil structure and site conditions, the pollutants are likely to penetrate into the aquifer and pollute the groundwater. When oil spills have low solubility, they will gradually infiltrate into the aquifer through the soil, form non-aqueous phase liquids (NAPLs), and then slowly dissolve into groundwater. Therefore, total petroleum hydrocarbon (TPH) pollution is considered to be a serious ecological and public health problem. After the petroleum hydrocarbons leak into the soil, they will quickly seep into the groundwater and form a wide-ranging contamination mass, which increases the difficulty of remediation (Wade et al., 2016). In the United States, 25% of water (including drinking water, agricultural water, industrial water, etc.) comes from groundwater, and 50% of drinking water comes from groundwater. In Taiwan, about 12.53% of tap water sources are groundwater (Taiwan Water Supply Corporation, 2019). Therefore, the protection of groundwater resources is extremely important. Therefore, the protection of soil and groundwater resources and the remediation of soil and groundwater pollution have reached an urgent level.

Therefore, oil pollution is one of the main pollution sources of soil and groundwater pollution. Because oil-polluted sites require a long remediation time, and if traditional physical and chemical remediation methods are used, higher remediation costs are required, and biological treatment requires consideration of biological tolerance to the environment and the remediation process is long.

In many different pollution site remediation projects, two main problems are usually encountered: 1. It is difficult to find suitable technologies; 2. It is not easy to establish rules for evaluating and selecting various technologies under specific site conditions.

Introduction of in-situ chemical oxidation technology: In situ chemical oxidation (ISCO) technology can decompose and destroy petroleum hydrocarbons in situ, and compared with other remediation technologies, pollutants can be reduced and degraded in a short time. The principle is a method of delivering oxidants into subsurface soils and aquifers to convert contaminants of concern (COC) and reduce their mass, mobility and/or toxicity (Devi et al., 2016; Ji et al., 2017; Li et al., 2018). This method can be used alone or in combination with other processing methods. Compared with other remediation methods, it has the following advantages: reduced remediation costs, reduced processing time, reduced excavation and soil disposal costs, and the ability to treat contaminated areas without affecting ground structures (Chen et al., 2016). The ISCO method is most suitable for high-concentration groundwater contamination clusters, and costs must be considered when used in low-pollution clusters. Several chemical oxidants are currently used in various contaminated sites.

Oxidants currently used to treat pollutants include Fenton's reagent, ozone, permanganate (KMnO4) and persulfate. The in-situ chemical oxidation method has a very wide range of applications, whether it is a pollution source area or a pollution cluster area, it has its potential application, but attention must be paid to the injection dose to avoid affecting the local microbial ecology (Apul et al., 2016; Xu et al. al., 2017). Hydrogeological conditions are a very important evaluation factor during field exploration, because this factor often limits the effectiveness of chemical oxidants in contact with contaminants. In general, chemical oxidants are not easily poured into homogeneous or heterogeneous low permeability soils containing large amounts of petroleum contaminants. The oxidation rate of on-site oxidants is affected by many factors, including temperature, pH, pollutant concentration, catalyst, by-products, background water quality, and organic matter (Srivastava et al., 2016). If chemical oxidants are used in soil, it is easy to cause organic matter and pollutants to compete with oxidants, resulting in the loss of oxidants and increasing remediation costs.

Although the general pH value of the Fenton method can be close to neutral, if the pH value is controlled between 2 and 4, it is more conducive to the formation of OH. Therefore, if acidic liquid is injected to control the pH value, it is necessary to consider the impact on the ecosystem. H2O2 produces oxygen and heat, has caused explosions and fires, and even caused groundwater to boil at 11% concentration. The main disadvantages of other H2O₂ applications include ineffective reactions (i.e. solid oxygen demand, SOD), a small pH range (between 3-5), and, depending on site conditions, resulting Free hydrogen will be captured by CO₃²⁻ and HCO₃₋, etc.

Persulfate does not have strong oxidizing effect at ordinary temperature. It is usually accompanied by temperature increase, UV or activator to initiate the mechanism of free radical production. However, when the temperature is too high, the decomposition rate of persulfate itself may be faster than that of organic matter. When persulfate and organic matter undergo oxidative degradation, the reaction process is also affected by pH value. Under alkaline conditions, the rate of persulfate oxidation of organic substances is slower than that under acidic conditions. Increasing pH reduces the reaction rate of persulfate with methyl tertiary butyl ether (MTBE), which may disappear due to the immediate reaction of SO₄—. and .OH with hydroxide ions (OH—). Under the condition of strong acid (pH 1.2), the removal rate of nicotinic acid will be faster than that under alkaline environment (pH 12), but slower than that under neutral condition (pH 5). Therefore, if the pH range in the environment is extremely acidic or extremely alkaline, the oxidation of persulfate will not be significantly helpful.

### SUMMARY OF THE INVENTION

In view of the above, the present invention considers reducing and degrading pollutants in a short time and chemical oxidation technology has more development potential in application, and in chemical oxidation technology, electrocatalysis technology is currently relatively new oxidation technology. A large number of free radicals and microbubbles can be generated through the catalytic process to degrade and remove the target pollutants. The main purpose of the present invention is to utilize the highly oxidizing substances (such as hydroxyl radicals, superoxide radicals, chlorine radicals, etc.) generated by the high-voltage electric field in the electrocatalytic system through the catalytic electrode to treat oil-contaminated groundwater and soil.

The advantages of the present invention include no chemical addition, no pH adjustment, low operation and maintenance costs, and fast processing speed. The micro-bubble high-oxygen water and acidic and alkaline water produced by the electrocatalytic process can be used as an additive and adjustment solution for local soil restoration, so it has a wide range of applications and can achieve the goal of simultaneously treating soil and groundwater. The developed technology complies with the current domestic and international promotion of green remediation on site, no secondary pollution and no chemical addition, which can effectively reduce the cost of remediation and is an energy-saving and environment-friendly construction method that is more economical and breaks through traditional design thinking.

### Effects Compared to the Prior Art

The present invention has the following advantages:

1. The electrocatalytic technology does not require additional chemical agents, so there is no need to consider whether the chemicals will affect the ecology like the Fenton method, nor whether the chemicals need to be combined with some addition conditions, such as the effects of pH and temperature, reducing oil contaminated groundwater and soil treatment costs and improving the speed of treatment of pollutants and treatment time.

2. The pioneering point of this technology is to combine a catalytic catalyst with a stable electrode that can exchange cathode and anode. By adding a catalyst to prolong the concentration and temporary storage rate of free radicals per unit time, there is no need to add additional chemicals, nor to adjust pH and temperature. Through the innovative electrocatalytic system with added catalyst, and after testing with Rhodamine B (RhB) as the probe, it was found that the measured value of free radical concentration per unit time was higher than that of the traditional electrocatalytic method without added catalyst. The reason is that the catalyst increases the temporary storage rate of free radical concentration, so that the concentration of free radicals that can react with pollutants per unit time increases, and the remediation effect of the innovative electrocatalytic system is increased.

3. The micro-bubble high-oxygen water and acidic and alkaline water produced by the electrocatalytic process can be used as an additive and adjustment solution for soil restoration in the field, and the electrocatalytic water has a long reaction time in the groundwater body, which can be effectively transmitted to a wider range, so it has a wider range of applications and can achieve the goal of simultaneously treating soil and groundwater.

4. Electrocatalytic technology conforms to the current domestic and international promotion of green remediation, which is on-site, no secondary pollution, and no chemical additions.

### BRIEF DESCRIPTION OF THE DRAWINGS

FIG. 1 is a schematic diagram of the present invention, which is a practical application of electrocatalytic technology to the groundwater remediation of polluted soil and groundwater.

FIG. 2 is a structural diagram of the electrocatalytic device of the present invention.

FIG. 3 is a schematic diagram of the present invention, which is a practical application of electrocatalytic technology to the on-site remediation of polluted soil and groundwater.

FIG. 4 is a schematic diagram of the electrocatalytic water hydroxyl radical generation mechanism of the present invention.

FIG. 5 is a graph of the turbidity change in water of the electrocatalytic system of the present invention.

FIG. 6 is the zeta potential analysis distribution chromatogram of the present invention.

FIG. 7 is the analysis chart of the bubble particle size of the uncatalyzed and catalyzed water of the present invention.

FIG. 8 is the analysis chart of the bubble concentration of uncatalyzed and catalyzed water of the present invention.

FIG. 9 is a classification diagram of the size of bubbles in the electrocatalytic water in the present invention.

FIG. 10 is a diagram of the surface electric double layer structure of the electrocatalytic water microbubble of the present invention.

FIG. 11 is a schematic diagram of the particle size of microbubbles in the electrocatalytic water and the zeta potential of the present invention.

FIG. 12 is a schematic diagram of the influence of surface tension on microbubbles in the electrocatalytic water of the present invention.

FIG. 13 is an enlarged schematic diagram of the state difference between the electrocatalytic water bubbles and microbubbles in water of the present invention and the decomposition of a single microbubble in water into other products shown on the right.

FIG. 14 is an analysis diagram of the electrocatalytic water hydroxide free radical duration concentration of the present invention.

FIG. 15 is an analysis diagram of the TPHD concentration of the electrocatalytic water in situ leaching of the present invention.

FIG. 16 is an analysis diagram of the TPHD concentration of the electrocatalytic water off-ground mud phase of the present invention.

FIG. 17 is an analysis diagram of the TPHD concentration of the electrocatalytic water off-ground mud phase stirred liquid phase of the present invention.

### DETAILED DESCRIPTION OF THE PREFERRED EMBODIMENT

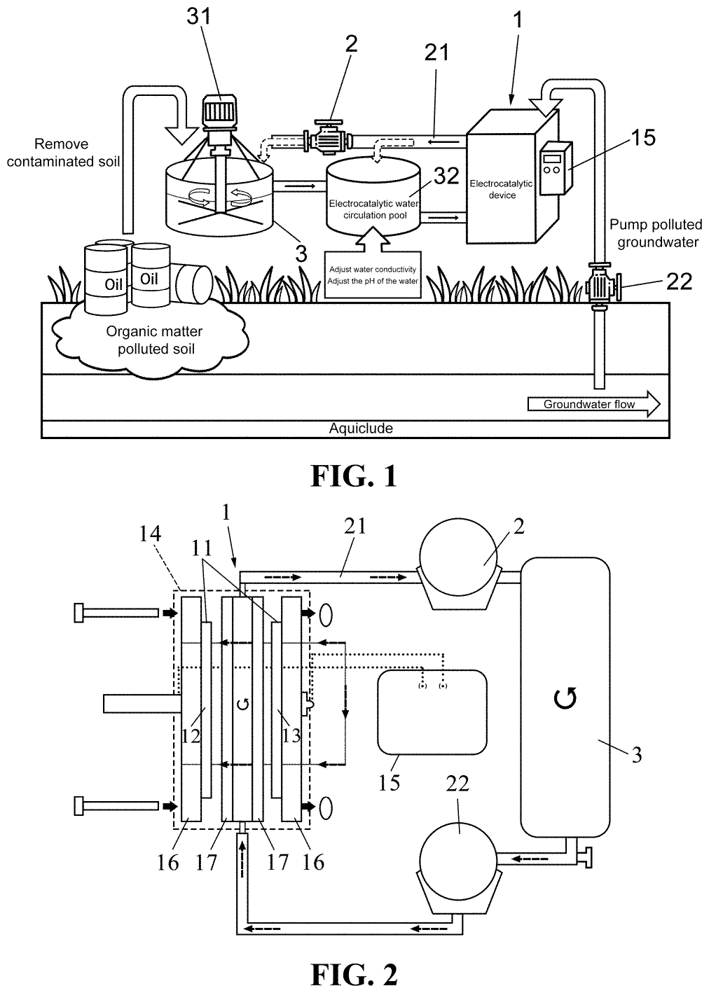

Please refer to FIG. 1 and FIG. 2, which are the embodiment of the present invention applying electrocatalytic technology to polluted soil and groundwater remediation. The oil-contaminated soil and groundwater treatment system of the present invention comprises an electrocatalytic device 1, an electrocatalytic water circulation pool 32, a reaction tank 3 and water pumps 2, 22. The electrocatalytic device 1 comprises at least one set of electrodes 11, a catalytic chamber 14, a power supply 15, at least one set of Teflon outer plates 16 and at least one set of insulating gaskets 17. Each set of electrodes 11 includes an anode 12 and a cathode 13. The anode 12 and the cathode 13 are set in the catalytic chamber 14. The insulating gasket 17 is located on the opposite inner side of the anode 12 and the cathode 13. The Teflon outer plates 16 are located on the outside of the anode 12 and the cathode 13, respectively. The electrocatalytic device 1, the electrocatalytic water circulation pool 32 and the reaction tank 3 are provided with a circulating pipe 21 to communicate with each other. The circulating pipe 21 is provided with a water pump 2. The power supply 15 supplies power to the electrocatalytic device 1 so that a high-voltage electric field is generated between the anode 12 and the cathode 13. By the water pump 22, the polluted groundwater is pumped into the electrocatalytic device 1, and the polluted soil is placed in the reaction tank 3. The polluted groundwater pumped into the electrocatalytic device 1 uses the high voltage electric field between the anode 12 and the cathode 13 in the electrocatalytic device 1 to change the structure of the water molecule through the direct current electric field. After high voltage discharge, electrocatalysis and electrolysis, alkaline reduced water, acidic oxidized water and neutral water with pH values of 11˜12, 2˜3, and 7 can be quickly produced. The generated electrocatalytic water is pumped by the water pump 2 through the circulating pipe 21 to flow into the reaction tank 3 with the polluted soil to be treated, and the electrocatalytic water and the polluted soil are fully stirred by a stirrer 31. By the oxidation effect of the anode 12 in the electrocatalytic device 1, the chloride ions and dissolved oxygen in the water produce hypochlorous acid (HClO) and superoxide ions (superoxide, O₂⁻), and the two interact to generate hydroxyl radicals. In addition, the energy released by the charged microbubbles gradually disintegrating in the water interacts with water molecules to generate transient hydroxyl radicals. This electrocatalytic technology generates hydroxyl radicals and microbubbles with high oxidizing ability and long-lasting oxidation, thereby effectively remediating the soil and groundwater polluted by total petroleum hydrocarbons (TPH). The aforementioned part of the electrocatalytic water pumped through the circulating pipe 21 by the water pump 2 enters the electrocatalytic water circulation pool 32 to adjust the conductivity and the pH value with the electrocatalytic water returned by the reaction tank 3, and then it returns to the electrocatalytic device 1 for reuse.

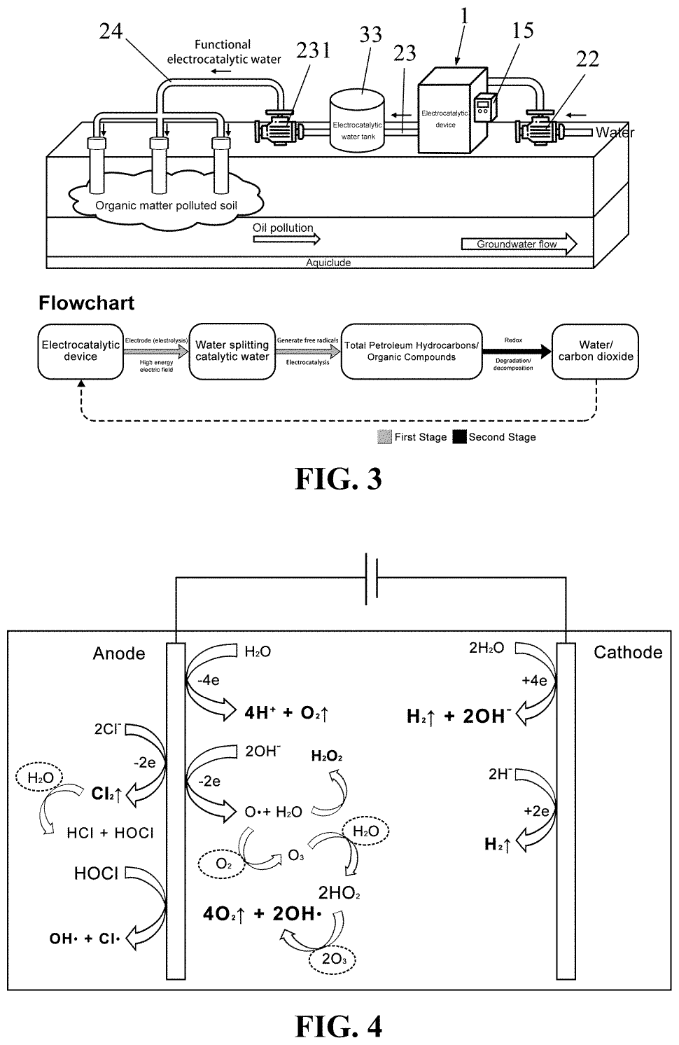

Please refer to FIG. 3 again, which is an embodiment of the present invention applying electrocatalytic technology to polluted soil and groundwater remediation, which comprises an electrocatalytic device 1, an electrocatalytic water tank 33, water pumps 22, 231, a conduit 23 and a drainpipe 24. The electrocatalytic device 1 comprises at least one set of electrodes 11, a catalytic chamber 14, a power supply 15, at least one set of Teflon outer plates 16 and at least one set of insulating gaskets 17. Each set of electrodes 11 includes an anode 12 and a cathode 13. The anode 12 and the cathode 13 are set in the catalytic chamber 14. The insulating gasket 17 is located on the opposite inner side of the anode 12 and the cathode 13. The Teflon outer plates 16 are located on the outside of the anode 12 and the cathode 13, respectively. Between the electrocatalytic device 1 and the electrocatalytic water tank 33, the conduit 23 is provided to communicate with each other. The water outlet of electrocatalytic water tank 33 is connected to the drainpipe 24. A water pump 231 is installed between the drainpipe 24 and the electrocatalytic water tank 33. At the same time, there is also a water pump 22 at the water inlet end of the electrocatalytic device 1. The tap water is drawn into the electrocatalytic device 1 by the water pump 22. The tap water drawn into the electrocatalytic device 1 uses the high-voltage electric field between the anode 12 and the cathode 13 in the electrocatalytic device 1 to change the structure of the water molecule through the DC electric field. After high voltage discharge, electrocatalysis and electrolysis, electrocatalytic water including alkaline reduced water, acidic oxidized water and neutral water can be quickly produced. The generated electrocatalytic water flows into the electrocatalytic water tank 33 through the conductor 23 for buffer storage. Then, the electrocatalytic water in the electrocatalytic water tank 33 is extracted from the drainpipe 24 at the end by means of the water pump 231 between the drainpipe 24 and the electrocatalytic water tank 33 and directly discharged into the contaminated soil on site and infiltrated into the ground. By the oxidation effect of the anode 12 in the electrocatalytic device 1, the chloride ions and dissolved oxygen in the water produce hypochlorous acid (HClO) and superoxide ions (superoxide, O₂—), and the two interact to generate hydroxyl radicals. In addition, the energy released by the charged microbubbles gradually disintegrating in the water interacts with water molecules to generate transient hydroxyl radicals. By means of electrocatalytic technology, hydroxyl radicals and microbubbles with high oxidizing ability and long-lasting oxidation are generated, so as to effectively remediate soil and groundwater polluted by total petroleum hydrocarbons (TPH).

The aforementioned electrode 11 uses a dimensionally stable anode (DSA) as a catalyst electrolytic electrode. The dimensionally stable anode (DSA) made of titanium base metal. The surface of the electrode is covered with a conductive iridium oxide coating. This enables the electrode 11 to operate at high current density, with a longer service life, low cost and high chemical and electrochemical stability.

In the metal catalyst part, the Bi—Sn—Sb/γ-Al₂O₃ particle electrode was prepared by impregnation and high temperature calcination to generate .OH to effectively treat organic pollutants in water. In the metal catalyst part, co-precipitation and calcination modified iron oxide are used as catalysts to improve the reactivity of hydrogen peroxide, effectively generate .OH and increase the initial concentration of pH value. Microwave treatment was used to replace Fe²⁺ with Mn²⁺ to improve the amount of sludge produced after treatment and the limited use of pH value. The researchers also used carbon material as a carrier, using the covalent properties of its activated functional groups to combine various metal ions to remove pollutants and degrade them for oxidation.

In the aforementioned electrocatalytic technology, the electrocatalytic water is produced by the supergaseous electron flow technology with a high energy field. It can be controlled by technology in the electrocatalytic device, which can quickly generate a large amount of alkaline reduced water, acidic oxidized water and neutral water, and the water contains a large number of transient free radicals, and the pH value and redox potential of water can be adjusted arbitrarily to produce water with high reducibility or high oxidation. The electrocatalytic water can be irrigated or sprayed to the soil according to the nature and remediation needs of the land to be rehabilitated. Electrocatalytic remediation of polluted soil is mainly based on the strong oxidizing, strong reducing and adjustable redox potential of electrocatalysis, which can decompose or redox the harmful substances, chemical residues, oily heavy metals and other substances in the soil. That is, using ordinary tap water, through electrocatalytic equipment, the treated highly oxidizing water is sprayed on the polluted land. After a period of electrocatalytic water reaction, the residual pollutants in the soil are completely decomposed, degraded, redox and other processes, so that the soil returns to normal. Therefore, the present invention remediates polluted soil and groundwater on-site or off-site by electrocatalytic technology, and degrades pollutants through oxidation/reduction, thereby achieving the purpose of remediation.

The purpose of the present invention has been described above to develop an innovative electrocatalytic technology to remediate total petroleum hydrocarbon (TPH)-contaminated soil and groundwater with hydroxyl radicals and microbubbles generated by the electrocatalytic technology. In addition, the present invention provides the parameters required for pollution site remediation by laboratory electrocatalysis and oxidation tests, obtains the removal mechanism and efficiency of electrocatalytic water to total petroleum hydrocarbons (TPH), and uses on-site field tests to verify the effect of electrocatalytic technology applied to field remediation. The laboratory batch research results of the present invention show that adding different concentrations of electrolytes can effectively increase the concentration of hydroxyl radicals to 6.2×10⁻¹³ to 7.4×10⁻¹³ M and the redox potential (800-850 mV), and accelerate oxidation rate of total petroleum hydrocarbons (TPH). The present invention uses a nanoparticle tracking analyzer for microbubble analysis. The analysis results show that electrocatalytic water (ECW) contains nanobubbles (41-51 nm), and the bubble concentration ranges from 9.2×10⁷ to 1.7×10⁸ particles/mL and has a high negative zeta potential. Due to the slow rising speed of nanobubbles, the slow disintegration of charged microbubbles releases transient OH. that interacts with water molecules and contributes to the degradation of total petroleum hydrocarbons (TPH) in water. Electron paramagnetic resonance (EPR) qualitative analysis of OH. showed that electrocatalytic water (ECW) has a high-intensity free radical signal. The present invention also uses Rhodamine-B (RhB) reagent as an indicator of oxidative ability to detect the concentration of free radicals. The test results show that the OH. concentration in the electrocatalytic water ranges from 6.2×10⁻¹³ to 7.4×10⁻¹³ M, which can effectively carry out the oxidative degradation of total petroleum hydrocarbons (TPH). According to the batch test results, electrocatalytic water (ECW) can degrade about 79.6% of the total petroleum hydrocarbons (TPH) in the soil, and can effectively deal with the soil total petroleum hydrocarbons (TPH) pollution in a short time. The present invention selects a gas station polluted site for on-site field test, and sets an electrocatalytic water injection well and three downstream monitoring wells at the site to evaluate the treatment efficiency of total petroleum hydrocarbons (TPH)-contaminated groundwater after electrocatalytic water infusion. In addition, a mud-phase reaction tank was also set up on site to evaluate the efficiency of electrocatalytic water treatment of total petroleum hydrocarbons (TPH)-contaminated soil in an off-ground manner. The assessment results showed that the total petroleum hydrocarbon (TPH) concentration in soil was between 1,196 and 3,530 mg/kg, the total petroleum hydrocarbon (TPH) concentration in groundwater was between 40.14 and 19.46 mg/L, and the hydraulic conductivity was 7.3×10⁻⁵ m/s, the groundwater flow direction is from south to north. The results of the on-site remediation test showed that after three batches of electrocatalytic water treatment, the removal rate of total petroleum hydrocarbons (TPH) in the soil could reach 80%, and the concentration of total petroleum hydrocarbons (TPH) was reduced to 1,000 mg/ kg (regulatory standard) or less. After the groundwater was injected with 1.5 tons (three pore volumes) of electrocatalytic water, the total petroleum hydrocarbons (TPH) in the injection well could reach a removal rate of 62%, and the concentration had been reduced to below 10 mg/L (regulatory standard). The present invention is known from the results of the mold field off-ground remediation test, the results of the fouling field test confirmed that the innovative electrocatalytic water system developed in the present invention can effectively treat the soil and groundwater polluted by total petroleum hydrocarbons (TPH), and achieve the goal of remediation in a short time. The use of electrocatalytic water for field remediation only requires electricity and field perfusion equipment. From the results of the field test, it can be estimated that 240 kWh of electricity is required for each ton of polluted soil in the off-ground mud phase, and the power consumption for three times of on-site rinsing and pouring is 15.9 kWh. The cost is initially estimated at 1.5 to 2.5 thousand NT dollars. The present invention will strengthen the reaction effect of the electrocatalytic system by means of a catalyst in the second year, and prepare the catalyst in batch experiments in the laboratory, and evaluate the optimal operating parameters of the electrocatalytic system. The improved electrocatalytic system was applied to the field test to evaluate the effectiveness of technology scale-up and the feasibility of applying it to field remediation.

Therefore, the electrocatalytic water produced by the electrocatalytic device of the present invention has the following characteristics for remediating soil pollution:

1. Directly poured into monitoring wells or watered on polluted soil, electrocatalytic water degrades organic toxic and harmful substances through chemical reactions such as oxidation and reduction, and quickly decomposes macromolecular harmful substances in soil.

2. Continuously monitor water pH and redox potential (ORP) to improve soil value and degradation of soil redox potential (ORP) to convert heavy metals into non-toxic and harmless salts or other stable substances.

3. The electrocatalytic water has a strong bactericidal function, which can quickly degrade hormones, pesticides, oil and other substances and eliminate odors.

4. The electrocatalytic water itself is transformed into ordinary water after leaving the water system for a period of time, without secondary pollution.

5. It has a wide range of applications and is suitable for all kinds of soil pollution remediation.

Description of the characteristics of electrocatalytic water conditioning:

1. Neutral electrocatalytic water is mainly for the treatment of soil contaminated by volatile organic compounds (VOCs), contaminated soil containing oil, and chemical pesticides and other contaminated soil treatment.

2. Acidic/alkaline electrocatalytic water can change the soil redox potential (ORP), as long as the soil polluted by heavy metals is treated and converted into non-toxic and harmless salts or other stable substances, the electrocatalytic equipment can be adjusted and treated according to the type of heavy metals and the degree of pollution.

3. Acid/neutral electrocatalytic water can efficiently decompose oil pollution.

4. The comprehensive utilization of electrocatalytic water mainly focuses on the treatment requirements of polluted soil, determines the adjustment of electrocatalytic water equipment, and conducts hierarchical governance.

According to the function of electrocatalytic water, the topsoil layer is first treated to degrade organic harmful substances, and heavy metals are converted into non-toxic and harmless salts or other stable substances. A sufficient amount of electrocatalytic water will infiltrate the transition layer and parent soil layer, continue to decompose and redox other organic harmful substances, and convert heavy metals into non-toxic and harmless salts or other stable substances. After the soil is renovated, the transition layer and the parent soil layer will be tilled and treated by electrocatalysis. After a period of time, the harmful substances are completely eliminated, and the soil will return to its natural state. Known general technology soil remediation process is relatively long, the treatment cycle is long, it is difficult to see the effect in the near future. Electrocatalytic water greatly shortens the soil remediation cycle, and the effect is obvious.

I. Principle of Electrocatalytic Water Technology:

1. Strong electric field ionization:

The plasma reaction process in which O₂ dissociates (ionizes) to generate hydroxyl radicals, in the strong ionization discharge, the electrons accelerated in the discharge electric field have an average energy greater than 10 eV, when the electron energy reaches 12.5 eV, the plasma reaction process of reacting with O₂ molecules to generate .OH is as follows:

O₂+e⁻→O₂⁺+2e⁻ [Chem.1]

O₂+e⁻→O⁺+O+2e⁻ [Chem.2]

From [Chem.1], it can be shown that the oxygen molecules are positively charged and release electrons after being ionized by a strong electric field, and under the action of the electric field, O₂⁺ and H₂O molecules form hydrated ions [O₂+(H₂O)]. Its reaction formula is as follows:

O₂⁺+H₂O+M→O₂+(H₂O)+M [Chem.3]

where, M is a catalytic metal, which can reduce the ionization activation energy, and the main way to generate hydroxyl radicals is the decomposition of hydrated ions. Its reaction formula is as follows:

O₂+(H₂O)+H₂O→H₃O⁺+O₂+.OH [Chem.4]

O₂+(H₂O)+organic→H₃O+(OH)+CO₂ [Chem.5]

H₃O +(OH)+H₂O+e⁻→H₃O⁺+H₂O+.OH [Chem.6]

In [Chem.4] and [Chem.6], hydrated ions react with water molecules to obtain the product .OH. In the [Chem.5] electrocatalytic system, the combination of organic matter and hydrated ions will break the carbon-hydrogen bond and degrade, and produce products such as water and carbon dioxide. In this system, water molecules exist in the form of charged hydrates, so the energy reduction reaction will be terminated after leaving the electric field.

2. Electrocatalytic catalyst reaction:

A dimensionally stable anode (DSA) is used as a catalyst electrolysis electrode. The dimensionally stable anode (DSA) is made of titanium based metal. The electrode surface is covered with conductive iridium oxide coating. Dimensionally stable anodes (DSA) are characterized by longer lifetimes at high current densities. Commercially available and relatively low cost also has high chemical and electrochemical stability. In the past few years, many studies have compared the treatment of dye wastewater containing reactive chlorine produced by dimensionally stable anode (DSA) type anodes. Adding NaCl as electrolyte in wastewater can improve the oxidation ability of dimensionally stable anode (DSA). Compared with other electrodes, dimensionally stable anode (DSA) has high chemical and mechanical strength and higher current density. These anodes are mainly used in the presence of Cl⁻, producing active chloride oxides (Cl₂, HOCl and OCl⁻). Electrocatalyst electrolysis of Cl⁻ to produce local strong oxidant, the reaction pathway is as follows: (1) Cl⁻ in water is an anode counter ion and adsorbs on the surface of the electrode, such as [Chem.7]. (2) Electrons transfer to the surface of the electrode to generate unstable chlorine radicals. On the one hand, it may combine to produce chlorine gas to achieve equilibrium, such as [Chem.8] and [Chem.9], and on the other hand, it directly reacts with the organic matter adsorbed on the surface of the electrode, such as [Chem.10] and [Chem.11], for heterogeneous oxidation. (3) Or desorb and recombine the chlorine on the surface of the electrode to oxidize the organic matter in the solution to carry out homogeneous oxidation, such as [Chem.12] and [Chem.13]. In addition, chlorine gas in water can be hydrolyzed to produce hypochlorous acid, which also has strong oxidative properties and can degrade organic matter.

S+Cl⁻⇄SCl.+e⁻(electrosorption) [Chem.7]

SCl⁻→SCl.++e⁻(electron transfer) [Chem.8]

2SCl.⇄SCl₂ (combination) [Chem.9]

S+R⇄SR (electrosorption) [Chem.10]

SCl.+SR→SCl⁻+SR (heterogeneous chemical reaction) [Chem.11]

SCl₂⇄S+Cl₂ (desorption) [Chem.12]

Cl₂+R→2Cl⁻+R (homogeneous chemical reaction) [Chem.13]

Cl₂+H₂O→HOCl+Cl⁻+H⁺ [Chem.14]

In the process of electrolysis of chlorine, in addition to the main products generated in the above situation, the products generated after electrolysis of water will exist for a short time and combine with the molecules in the water, wherein the dissolved oxygen in the water will be reduced to O₂⁻ in the cathode. The superoxide anion is formed when an additional electron is obtained mainly from the oxygen molecule in [Chem.15]. Its high activity and strong negative charge are easy to react with protons (hydrogen ions) in water to form hydrogen superoxide [Chem.16], and H₂O₂ can be produced under the metabolism of superoxide [Chem.17], and can be from superoxide anion or from H₂O₂. .OH can be formed by two reactions. If it is generated by O₂⁻, it is Haber-Weiss reaction [Chem.18]. If it is reacted by a divalent metal, it is a Fenton reaction [Chem.19].

O₂+e⁻→O₂⁻. [Chem.15]

O₂⁻.+H⁺→HO₂ [Chem.16]

2HO₂.→H₂O₂+O₂ [Chem.17]

O₂+e⁻→O₂⁻. [Chem.18] Haber-Weiss reaction

Fe²⁺+H₂O₂→Fe³⁺+OH⁻+.OH [Chem.19] Fenton reaction

The above-mentioned equation set is drawn out the situation diagram of the water when the dimensionally stable anode (DSA) electrolyzes the sodium chloride aqueous solution, as shown in FIG. 4, it can be found that: (1) due to the formation of chlorine gas by Cl⁻ in the water, the hydrogen ion is reduced to hydrogen in the cathode, and the pH value of the water will rise, however, due to the action of chlorine and sodium hydroxide to produce sodium chlorate, the pH value tends to be neutral; (2) chlorine free radicals in water come from hypochlorous acid and then react with anode and generate .OH at the same time; (3) dissolved oxygen in water is reduced to O₂⁻ at cathode, and forms hydrogen superoxide with hydrogen ions in water, and then generates H₂O₂, which can be obtained by Haber-Weiss reaction. From the above theory, it is deduced that the electrocatalytic water produced by dimensionally stable anode (DSA) is mainly a highly oxidative substance formed by Cl⁻ and dissolved oxygen in water after electrolysis and catalysis, and after electroremoval, hypochlorous acid, hydrogen superoxide and other values persist in water to prolong the oxidative capacity.

II. Basic Properties of Electrocatalytic Water:

1. Basic Features

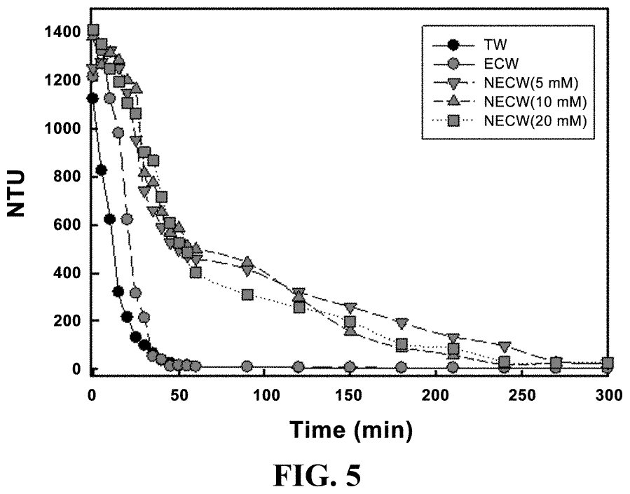

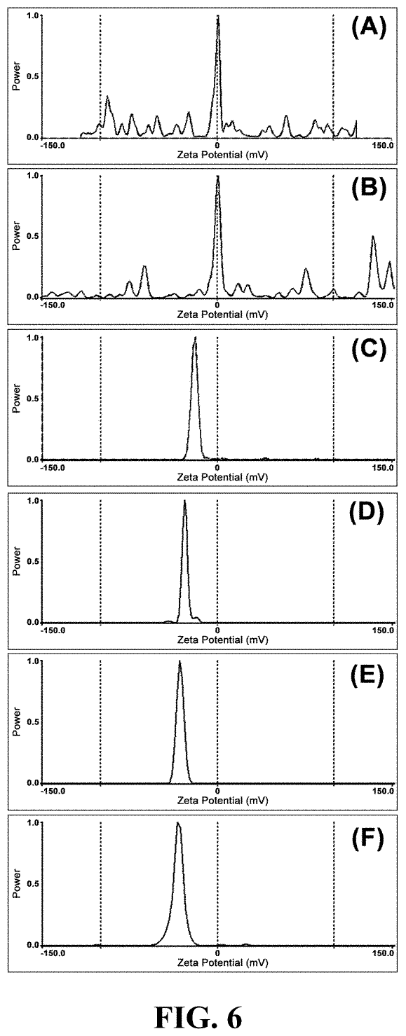

Experiments were carried out using NaCl as electrolyte and configuring different concentrations of solutions combined with electrolyzed catalytic water (ECW) system to produce neutralized electrolyzed catalytic water (NECW), the basic properties of electrocatalytic water are shown in [Table 1]. From the basic properties in the table, it can be found that the oxidation-reduction potential (ORP) of the basic properties increases significantly in the later stage of adding sodium chloride, indicating that the electrocatalysis produces a higher oxidation capacity when the electrolyte is sufficient, and the pH value is relatively stable. Therefore, basic parameters were analyzed for different electrolyte concentrations, and 20 mM NaCl was finally selected as the experimental parameters. The turbidity meter was used to analyze the concentration changes of suspended microbubbles in the electrocatalytic water, as shown in FIG. 5. The data found that without adding electrolyte (TW) and electrocatalytic water (ECW) groups, the electrocatalytic water (ECW) microbubbles through the electrocatalytic water system can be maintained for about 30 minutes, and after adding electrolyte (NaCl), the microbubbles in different groups all had longer existence time. Microbubbles are affected by surface tension in water, so the concentration of bubbles generated in the electrocatalytic system is only affected by the electrocatalytic current, and the existence time has a high relationship with the salinity of the water. Zeta-potential analysis was used to indicate the surface charge of micro/nanobubbles in water. FIG. 6 shows the experimental results, the electrocatalytic water produced by the tap water after passing through the electrocatalytic system, the zeta potential changed from the original neutral potential to a negative potential value. It is confirmed that the surface of micro/nanobubbles in water has a zeta potential after passing through the electrocatalytic system, which is beneficial to the generation of .OH, and by adding different concentrations of electrolytes, the zeta potential decreased more significantly. The results in FIG. 6 show that (C, D, E, and F) have an average zeta potential between −20 mV and −30 mV, indicating that the surface bubbles all have a negative zeta potential after passing through the electrocatalytic system.

TABLE 1
Basic properties of electrocatalytic water

| | | | | Zeta- |
|---|---|---|---|---|
| | Conductivity | ORP | | potential |
| Electrolyte | (mS/cm) | (mV) | pH | (mV) |
| D.I. water | <0.001 | 91~113 | 6.5~7.5 | −5.3 |
| Tap water | 0.057 | −150~182 | 6.5~7.5 | −14.5 |
| 5 mM NECW | 0.525 | 450~482 | 7.2~7.5 | −19.2 |
| 10 mM | 0.933 | 652~706 | 7.2~7.3 | −21.5 |
| NECW | | | | |
| 20 mM | 1.721 | 782~820 | 7.2~7.4 | −31.0 |
| NECW | | | | |
| 30 mM | 2.583 | 770~825 | 7.2~7.4 | −34.5 |
| NECW | | | | |

2. Size and Concentration of Bubbles in Electrocatalytic Water

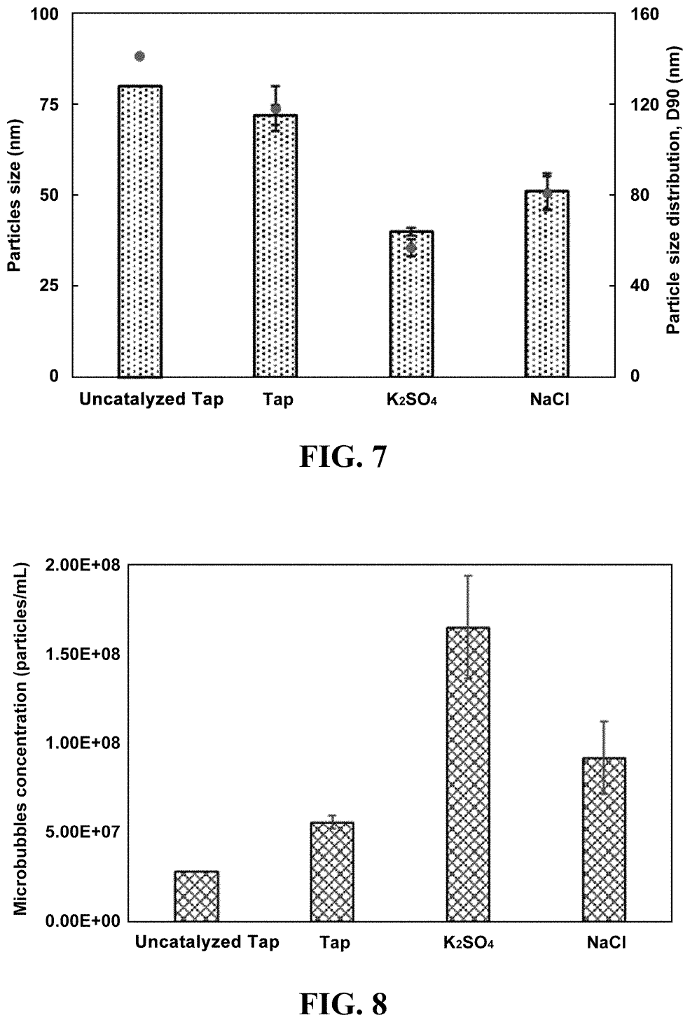

The concentration of nanobubbles in water was analyzed using a nanoparticle tracking analysis. The Brownian motion of the particles with scattered light in the solution is mainly observed by a microscope, and the particle size, scattered light intensity, quantity and concentration of the particles are detected according to the size of the bubbles in the water, and the results are shown in FIG. 7. The average particle size of the bubbles in uncatalyzed tap water is 80 nm, and the 90% particle size (D 90) distribution is 141 nm. The average particle size of the bubbles in the catalyzed tap water is 72±3 nm, and the D 90 distribution is 118±10 nm. After adding 20 mM potassium sulfate and sodium chloride, the average particle size of bubbles was 40±1 and 51±5 nm, respectively, and the D 90 distribution was 57±4 and 81±7 nm, respectively. According to the analysis results of air bubble concentration in water, as shown in FIG. 8, the average concentration of air bubbles in uncatalyzed tap water was 2.8×107 particles/mL; the average concentration of bubbles in catalyzed tap water was 5.6×107±3.8×106 particles/mL; the average bubble concentrations after adding 20 mM potassium sulfate and sodium chloride were 1.7×108±2.9×107 and 9.2×107±2.0×107, respectively. Experiments have confirmed that the catalytic water produced by the electrocatalytic system can generate high concentration of nano-bubbles in the water when adding salts to increase the catalytic performance. Among them, nanobubbles with small particle size and high concentration can be obtained by adding 20 mM potassium sulfate to the catalytic group, followed by adding 20 mM sodium chloride.

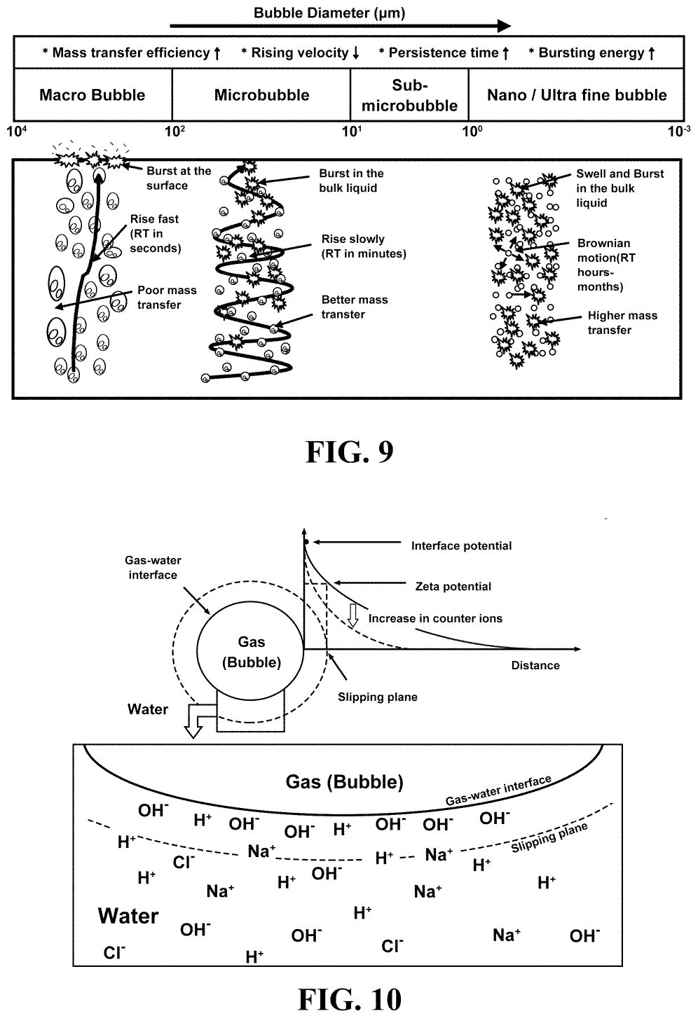

Then according to the type and characteristics of the bubbles, the description is as follows: According to the size of the bubbles in water, it can be divided into four types: macro bubble, microbubble, sub-microbubble and nano/ultra fine bubble, as shown in FIG. 9. The size of macro bubble is between 102-104 μm, microbubble is between 101-102 μm, sub-microbubble is between 100-101 μm and nano/ultra fine bubble is between 10-3-100 μm. When the size of the bubbles is smaller, the rising speed of the bubbles decreases, the mass transfer rate, the duration, and the energy rises when bursting.

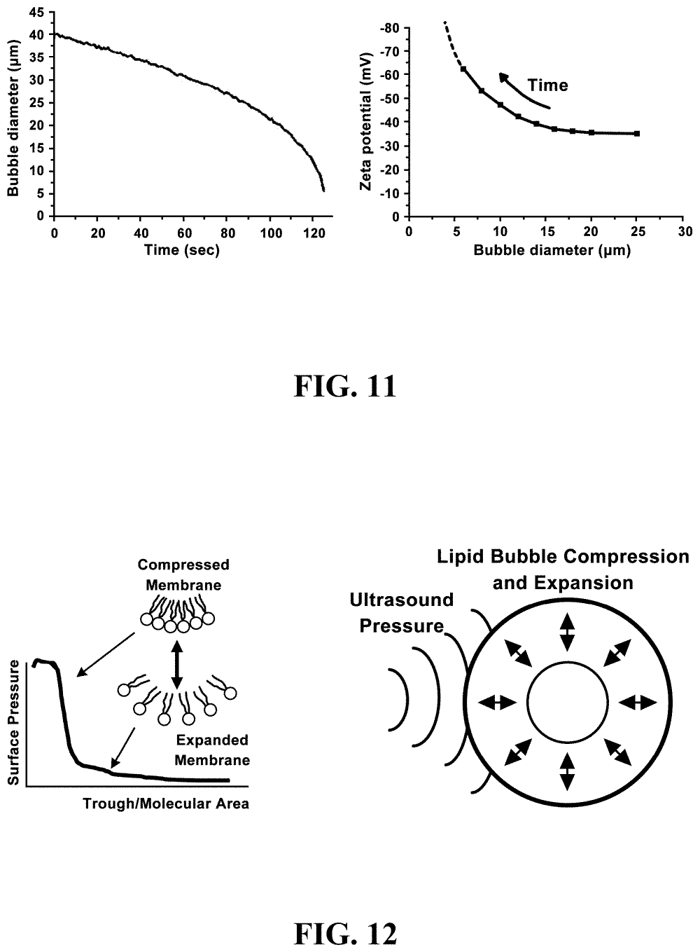

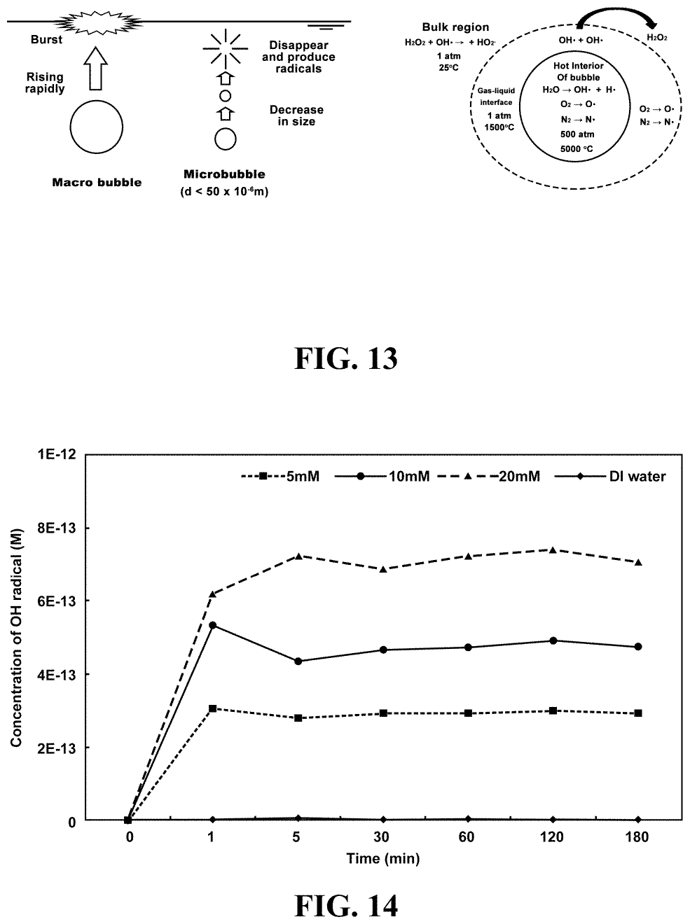

The formation of bubbles in water is mainly a static or quasi-static process followed by a dynamic process, that is, the process of coalescence and rupture. The formation, growth and decomposition of bubbles can be represented by cavitation. In the case of coalescence, fine bubbles combine into larger bubbles, and when the bubbles collapse, smaller bubbles may be formed. The formation of bubbles is a physical phenomenon, which is related to surface tension and energy deposition. The most commonly used method in water treatment technology is hydrodynamic cavitation, which can generate air bubbles by means of pressure, shear force, ultrasound, electrochemistry and mechanical disturbance. According to the report, the potential value of gas microbubbles in water is between −20 and 50 mV. Taking oxygen microbubbles as an example, the surface zeta potential of microbubbles in water will remain at −30 mV after 90 minutes. In 2007, Takahashi proposed that the surface of microbubbles has an electric double-layer structure due to pressure and water molecules (Takahashi et al., 2007), as shown in FIG. 10. The large number of micro/nanobubbles generated during the electrocatalytic process also contribute to the generation of .OH. The study further found that the micro/nano bubbles in water shrink with time. While the bubble size is gradually reduced in water, the adiabatic compression processes make the internal pressure of the bubble extremely large and change the zeta potential of the bubble surface as shown in FIG. 11. These charged microbubbles gradually disintegrate in the water, and the released energy interacts with water molecules to produce transient .OH. In the study of the surface tension of microbubbles in the ultrasonic system (as shown in FIG. 12), it can be found that if the microbubbles are affected by pressure, ionic strength, temperature, viscosity and other conditions, the surface tension can be reduced and the existence of microbubbles can be prolonged. In the electrocatalytic water system, electrolytes were used for the reaction in the past, so different electrolyte concentrations will affect the tension of the bubble surface, so that the duration of the microbubble effect can be prolonged. Due to the continuous existence of bubbles, the organic matter in the water is combined with the microbubbles and the organic matter is suspended in the water body to achieve the effect of leaching. The ability of microbubbles in water to corrode and oxidize is mainly due to the relationship of cavitation. Microbubbles in water can exist for a long time in water, as shown in the left of FIG. 13, when they exist in water, they compress and expand to form cavitation bubbles. When the bubbles are compressed and expanded alternately, a momentary vortex will be formed. According to the hot spot theory, these bubbles act as hot spots and exist in the liquid phase, and the medium in the adiabatic process then generates high temperature and high pressure (the local temperature can be as high as 5,000° C. and the local pressure can reach 500 atmospheres). Such extreme conditions cause the pyrolysis of water molecules and the formation of residual vapors within the dissociated bubbles and the formation of free radicals, which decompose the water molecules into hydrogen ions and .OH, as shown on the right in FIG. 13.

3. Hydroxide radical generation rate:

In the present invention, Rhodamine B (RhB) is used as a chemical probe to observe the addition of salts with different concentrations in the electrocatalytic system, and the water samples of running water are collected regularly to analyze and compare the .OH concentration. Due to the addition of NaCl for catalysis, hypochlorite will be generated at the same time, and hypochlorite will interfere with Rhodamine B (RhB) for .OH detection. Therefore, the salts in this experiment were replaced by potassium sulfate (K₂SO₄). The .OH concentration in water was estimated by substituting the analytical concentration of RhB in the effluent water into [Chem.20]. The experimental results are shown in FIG. 14, the concentration of .OH in uncatalyzed deionized water ranges from 2.8×10⁻¹⁵ to 7.4×10⁻¹⁵ M. Electrocatalytic water with 5 mM K₂SO₄ added, the .OH concentration ranged from 1.5×10⁻¹³ to 3.0×10⁻¹³ M. Electrocatalytic water with 10 mM K₂SO₄ added, the .OH concentration ranged from 4.3×10⁻¹³ to 5.3×10⁻¹³ M. Electrocatalytic water with 20 mM K₂SO₄ added, the .OH concentration ranged from 6.2×10⁻¹³ to 7.4×10⁻¹³ M. It can be seen from the data results that the amount of .OH in the water without electrocatalysis is significantly less, and its concentration has approached zero. When salt was added to the system for catalysis, the concentration of .OH in water increased significantly. And when the concentration of added salts is higher, the amount of .OH produced per unit time is relatively more, and its increasing trend is consistent with the results of electron paramagnetic resonance (EPR) analysis.

$$ln [ \frac{{C}_{RhB}}{{C}_{{RhB}_{0}}} ] = - k \cdot OH / RhB \times \int C \cdot OH \times t \qquad [ Chem . 20 ]$$

$$where k \cdot OH / RhB is 3.75 \pm 0.15 \times 109 M - 1 S - 1.$$

4. On-Site Remediation and Rinsing Mold Field Test

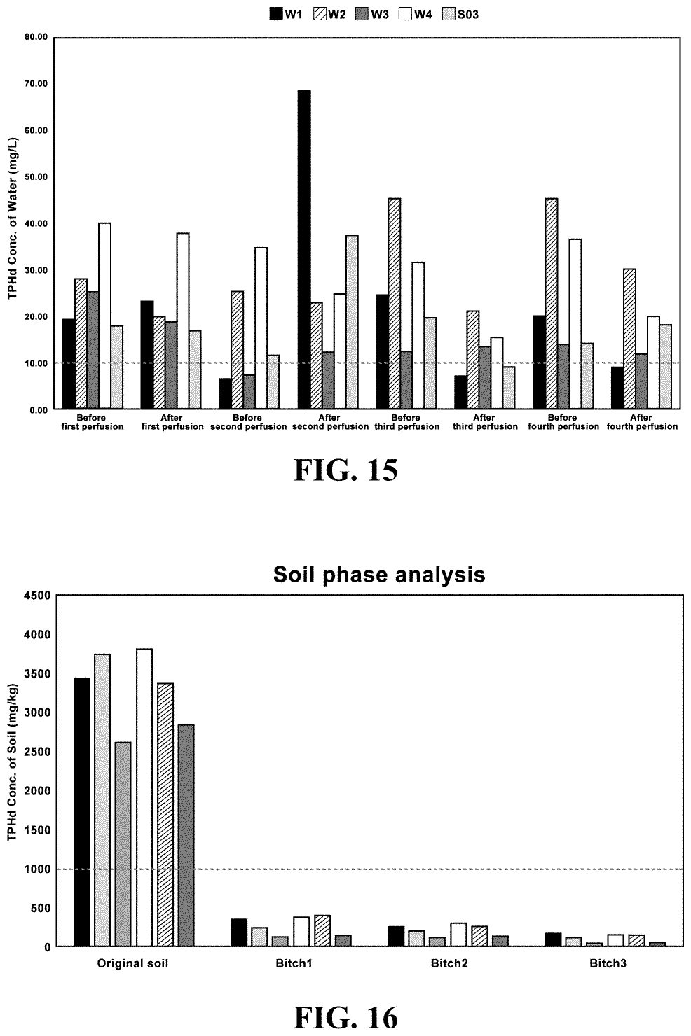

In this method, W1 was used as the injection well, and the target influence to W2 was used as the test first. W3, W4 and S03 are inspected downstream monitoring wells. Each time, the influence radius was 1 meter, the depth was 5 meters, and the soil porosity was 0.3. After calculation, 500 L was the perfusion volume for each batch. The sampling interval was 1 day before and after injection, 3 days between each injection. From the results shown in FIG. 15, after the first injection, W1 increased slightly. It is speculated that the electrocatalytic water will dissolve the total petroleum hydrocarbons (TPH) attached to the soil phase to the liquid phase in addition to degrading the soil phase pollutants. The concentration of the remaining wells decreased. It is speculated that the concentration of total petroleum hydrocarbons (TPH) recharged from further upstream is re-adsorbed by the soil around W1 due to the electrocatalytic water degradation of the original total petroleum hydrocarbons (TPH) in the upstream W1 soil phase, so that the concentration of total petroleum hydrocarbons (TPH) that continue to flow downstream from the well site itself is greater than that of new total petroleum hydrocarbons (TPH) from upstream reinjection. After the second perfusion, W1 increased significantly. It is speculated that the electrocatalytic water will remove some of the total petroleum hydrocarbons (TPH) reattached to the W1 soil phase after the first injection, and also dissolve some of the total petroleum hydrocarbons (TPH) into the liquid phase, and the rest of the well position changes are driven by the original groundwater flow. After the third perfusion, the concentration of W1 decreased significantly. It is speculated that the concentration of total petroleum hydrocarbons (TPH) recharged from further upstream is re-adsorbed by the soil around W1 because the original total petroleum hydrocarbons (TPH) in the soil phase of W1 are degraded by electrocatalytic water. Different from the first two times, the total petroleum hydrocarbon (TPH) concentration decreased after injection. It is speculated that the total petroleum hydrocarbons (TPH) initially adsorbed in the W1 soil phase are continuously removed by continuous infusion. Compared with the previous two injections, the residues kept decreasing, and a larger proportion of total petroleum hydrocarbon (TPH) contamination from further upstream re-injection was adsorbed in the soil phase of W1, resulting in a lower total petroleum hydrocarbon (TPH) concentration in the liquid phase. Changes in total petroleum hydrocarbon (TPH) concentrations at other well sites were driven by existing groundwater flow. The fourth well location concentration change principle is the same as the third. Wherein, since S03 is a well position parallel to W2, in addition to being indirectly affected by W1, the upstream of the original flow direction will also self-refill total petroleum hydrocarbons (TPH) pollution to S03. It can be seen from the results of the four washings that the reaction mechanism of electrocatalytic water in washing is that the removal reaction with total petroleum hydrocarbon (TPH) pollution starts from the injection well W1, then, the groundwater from which the total petroleum hydrocarbons (TPH) are removed is continuously reduced, and the pollutants recharged to the downstream are gradually reduced to achieve the remediation effect.

5. Off-Ground Remediation Mud Phase Stirring Field Test

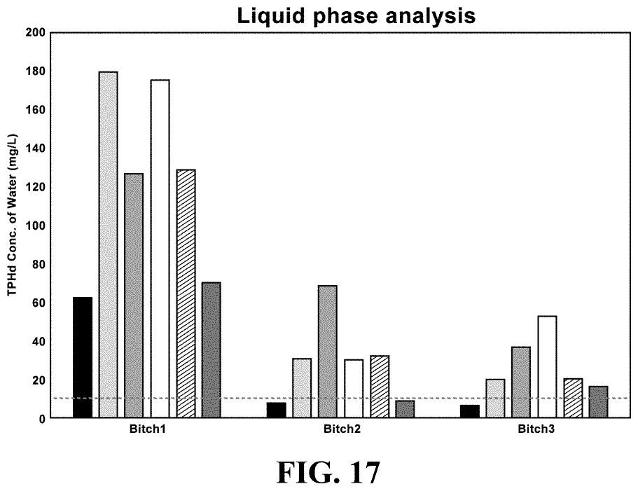

In this experiment, electrocatalytic water was generated with a current of 30 A, and the contaminated soil at different depths collected on the spot was mixed with 10 kg of contaminated soil and 40 L of electrocatalytic water for ten minutes per batch to carry out the off-ground mud phase stirring reaction, to test the change of total petroleum hydrocarbon (TPH) concentration of contaminated soil before and after stirring to verify the effect of off-ground mud phase stirring. It can be seen from the results shown in FIG. 16 and FIG. 17 that the initial total petroleum hydrocarbon (TPH) concentration of the first group was 3459 mg/kg, which decreased directly to 345 mg/kg after the first batch stirring, while the total petroleum hydrocarbon (TPH) concentration in the liquid phase only increased 63 mg/L; the initial concentration of the second group was 3753 mg/kg, which decreased directly to 247 mg/kg after the first batch was stirred, while the total petroleum hydrocarbon (TPH) concentration in the liquid phase increased by 180 mg/L; the initial concentration of the third group was 2621 mg/kg, which was directly reduced to 125 mg/kg after stirring in the first batch, while the total petroleum hydrocarbon (TPH) concentration in the liquid phase increased by 127 mg/L; the initial concentration of the fourth group was 3816 mg/kg, which was directly reduced to 378 mg/kg after the first batch of stirring, and the total petroleum hydrocarbon (TPH) concentration in its liquid phase increased by 176 mg/L; the initial concentration of the fifth group was 3281 mg/kg, which was directly reduced to 395 mg/kg after the first batch of stirring, while the total petroleum hydrocarbon (TPH) concentration in the liquid phase increased by 129 mg/L; the initial concentration of the sixth group was 2840 mg/kg, which decreased directly to 144 mg/kg after the first batch agitation, while the total petroleum hydrocarbon (TPH) concentration in its liquid phase increased by 70 mg/L. After the second and third batch reactions of three groups, the total petroleum hydrocarbon (TPH) pollution in the soil phase continued to decrease, but some groups were directly transferred from the soil phase to the liquid phase. Therefore, it can be known that the total petroleum hydrocarbon (TPH) pollution in the soil phase has reached the regulatory standard of less than 1000 mg/kg after the first batch of reaction, and from the change of the total petroleum hydrocarbon (TPH) concentration in the liquid phase, it can be known that nearly 80% of the total petroleum hydrocarbon (TPH) pollution in the soil phase was successfully removed. It can be seen from the two or three batch reactions that some of the more tenacious total petroleum hydrocarbon (TPH) contamination may still remain. It is speculated that it may be that the soil stirring is not uniform enough to cause the uneven mixing of the electrocatalytic water and the polluted soil, resulting in an incomplete reaction. However, most of the total petroleum hydrocarbon (TPH) contamination proved to be removed by electrocatalysis.

What the invention claimed is:

1. An oil-contaminated soil and groundwater treatment system, comprising an electrocatalytic device, an electrocatalytic water circulation pool, a reaction tank, a first water pump and a second water pump, said electrocatalytic device comprising at least one set of electrodes, a catalytic chamber, a power supply, at least one set of Teflon outer plates and at least one set of insulating gaskets, each said set of electrodes comprising an anode and a cathode, said anode and said cathode being set in said catalytic chamber, said at least one set of insulating gaskets being located on an inner side of said anode and said cathode of each said set of electrodes, said Teflon outer plates being located on the outside of said anode and said cathode of each said set of electrodes, said electrocatalytic device, said electrocatalytic water circulation pool and said reaction tank being provided with a circulating pipe to communicate with each other, said circulating pipe being provided with said first water pump, said second water pump being provided at a front side of said electrocatalytic device, the polluted groundwater being pumped into said electrocatalytic device by said water pump, the polluted soil being placed in said reaction tank, said power supply suppling power to said electrocatalytic device so that a high-voltage electric field is generated between said anode and said cathode, the polluted groundwater pumped into said electrocatalytic device using the high voltage electric field between said anode and said cathode in said electrocatalytic device to change the structure of the water molecule through the direct current electric field, after high voltage discharge, electrocatalysis and electrolysis, alkaline reduced water, acidic oxidized water and neutral water with pH values of 11˜12, 2˜3, and 7 being quickly produced, the generated electrocatalytic water being pumped by said first water pump through said circulating pipe to flow into said reaction tank with the polluted soil to be treated, and the electrocatalytic water and the polluted soil being fully stirred by a stirrer, by the oxidation effect of said anode in said electrocatalytic device, the chloride ions and dissolved oxygen in the water producing hypochlorous acid (HClO) and superoxide ions (O₂⁻), and the two interacting to generate hydroxyl radicals (.OH), in addition, the energy released by the charged microbubbles gradually disintegrating in the water interacting with water molecules to generate transient hydroxyl radicals, this electrocatalytic technology generating hydroxyl radicals and microbubbles with high oxidizing ability and long-lasting oxidation, thereby effectively remediating the soil and groundwater polluted by total petroleum hydrocarbons (TPH), in addition, a part of the electrocatalytic water pumped by said first water pump on said circulating pipe entering said electrocatalytic water circulation pool through said circulating pipe, the other part of the electrocatalytic water entering said reaction tank, and the electrocatalytic water returned from said reaction tank re-entering said electrocatalytic water circulation pool to mix with the original electrocatalytic water and adjusting the conductivity and pH value, and then returning to said electrocatalytic device for reuse.

2. The oil-contaminated soil and groundwater treatment system as claimed in claim 1, wherein said electrode is a dimensionally stable anode (DSA) as a metal catalyst electrolytic electrode, the dimensionally stable anode (DSA) is made of titanium-based metal, and the surface of the electrode is covered with a conductive iridium oxide coating.

3. The oil-contaminated soil and groundwater treatment system as claimed in claim 2, wherein in the metal catalyst part, the Bi—Sn—Sb/γ-Al₂O₃ particle electrode is prepared by impregnation method and high temperature calcination to generate .OH to effectively treat organic pollutants in water, in addition, co-precipitation and calcination-modified iron oxide are used as catalysts to improve the reactivity of hydrogen peroxide, effectively generate .OH and increase the initial concentration of pH value.

4. The oil-contaminated soil and groundwater treatment system as claimed in claim 1, wherein said electrocatalytic device generates a large number of micro/nano bubbles in the electrocatalytic process, which is conducive to the generation of .OH; the micro/nano bubbles in water have the characteristics of shrinking with time; when the bubble size is gradually reduced in water, the adiabatic compression process makes the internal pressure of the bubble extremely large and changes the zeta potential on the surface of the bubble, the energy released by these charged microbubbles gradually disintegrating in the water interacts with water molecules to produce transient .OH; in the electrocatalytic process, the electrolyte is used for the reaction, and the tension of the bubble surface is affected by different electrolyte concentrations, so that the duration of the microbubble effect can is prolonged; due to the continuous existence of bubbles, the organic matter in the water is combined with the microbubbles and the organic matter is suspended in the water body to achieve the effect of leaching.

5. The oil-contaminated soil and groundwater treatment system as claimed in claim 1, wherein adding salts to said electrocatalytic device during catalysis increases the .OH concentration in water, and when the added salt concentration is higher, the amount of .OH produced per unit time is relatively more.

6. An oil-contaminated soil and groundwater treatment system, comprising an electrocatalytic device, an electrocatalytic water tank, a first water pump, a second water pump, a conduit and a drainpipe, said electrocatalytic device comprising at least one set of electrodes, a catalytic chamber, a power supply, at least one set of Teflon outer plates and at least one set of insulating gaskets, each said set of electrodes comprising an anode and a cathode, said anode and said cathode being set in said catalytic chamber, said at least one set of insulating gaskets being located on an inner side of said anode and said cathode of each said set of electrodes, said Teflon outer plates being located on the outside of said anode and said cathode of each said set of electrodes, said conduit being set between said electrocatalytic device and said electrocatalytic water tank to communicate with each other, electrocatalytic water tank having a water outlet connected to said drainpipe, said first water pump being set between said drainpipe and said electrocatalytic water tank, said electrocatalytic device having a water inlet provided with said second water pump, said second water pump pumping the tap water into said electrocatalytic device, the tap water drawn into said electrocatalytic device being powered by said power supply to said electrocatalytic device, so that a high-voltage electric field is generated between said anode and said cathode, and the structure of the water molecule is changed by the DC electric field, after high voltage discharge, electrocatalysis and electrolysis, alkaline reduced water, acidic oxidized water and neutral water with pH values of 11˜12, 2˜3, and 7 being quickly produced, the generated electrocatalytic water flowing into said electrocatalytic water tank through the conduit for buffer storage, then, the electrocatalytic water in said electrocatalytic water tank being extracted from said drainpipe by said first water pump between said drainpipe and said electrocatalytic water tank, and being directly discharged to the local polluted soil and infiltrated into the ground, by the oxidation effect of said anode in said electrocatalytic device, the chloride ions and dissolved oxygen in the water producing hypochlorous acid (HClO) and superoxide ions (O₂⁻), and the two interacting to generate hydroxyl radicals (.OH), in addition, the energy released by the charged microbubbles gradually disintegrating in the water interacting with water molecules to generate transient hydroxyl radicals, this electrocatalytic technology generating hydroxyl radicals and microbubbles with high oxidizing ability and long-lasting oxidation, thereby effectively remediating the soil and groundwater polluted by total petroleum hydrocarbons (TPH).

7. The oil-contaminated soil and groundwater treatment system as claimed in claim 6, wherein said electrode is a dimensionally stable anode (DSA) as a metal catalyst electrolytic electrode, the dimensionally stable anode (DSA) is made of titanium-based metal, and the surface of the electrode is covered with a conductive iridium oxide coating.

8. The oil-contaminated soil and groundwater treatment system as claimed in claim 7, wherein in the metal catalyst part, the Bi—Sn—Sb/γ-Al₂O₃ particle electrode is prepared by impregnation method and high temperature calcination to generate .OH to effectively treat organic pollutants in water, in addition, co-precipitation and calcination-modified iron oxide are used as catalysts to improve the reactivity of hydrogen peroxide, effectively generate .OH and increase the initial concentration of pH value.

9. The oil-contaminated soil and groundwater treatment system as claimed in claim 6, wherein said electrocatalytic device generates a large number of micro/nano bubbles in the electrocatalytic process, which is conducive to the generation of .OH; the micro/nano bubbles in water have the characteristics of shrinking with time; when the bubble size is gradually reduced in water, the adiabatic compression process makes the internal pressure of the bubble extremely large and changes the zeta potential on the surface of the bubble, the energy released by these charged microbubbles gradually disintegrating in the water interacts with water molecules to produce transient .OH; in the electrocatalytic process, the electrolyte is used for the reaction, and the tension of the bubble surface is affected by different electrolyte concentrations, so that the duration of the microbubble effect can is prolonged; due to the continuous existence of bubbles, the organic matter in the water is combined with the microbubbles and the organic matter is suspended in the water body to achieve the effect of leaching.

10. The oil-contaminated soil and groundwater treatment system as claimed in claim 6, wherein adding salts to said electrocatalytic device during catalysis increases the .OH concentration in water, and when the added salt concentration is higher, the amount of .OH produced per unit time is relatively more.
